(19) United States
(12) Patent Application Publication
(10) Pub. No.: US 2009/0077754 A1
(43) Pub. Date: Mar. 26, 2009

(54) Buoyant hand tool

(76) Inventor: CHIH-CHING HSIEH, Fengyuan City (TW)

Correspondence Address: PHILLIP LIU, 6980, WHITEOAK DR., RICHMOND, BC, V7EAZ9, CA

(21) Appl. No.: 11/902,545

(22) Filed: Sep. 24, 2007

(51) Int. Cl. B25G 1/00; B25B 23/16

(52) U.S. Cl. 7/167; 81/489; 81/491

(57) ABSTRACT

A buoyant hand tool includes a handle composed of a first part and a second part which is connected to the first part by way of ultra sonic welding. Each of the first part and the second part includes a recess defined in an inside thereof so as to be cooperated to form a space in the handle. Each of the first and second parts includes a recess defined in an end thereof and the two respective recesses are cooperated to form a reception space in which a function member is securely received. The space in the handle is filled with air so that the handle floats in water.

### FIELD OF THE INVENTION

The present invention relates to a buoyant hand tool with a hollow handle which does not sink in water.

### BACKGROUND OF THE INVENTION

A conventional hand tool generally includes a handle and a shank which is made by metal and an end of the shank is fixed to a handle which is made by non-conductive material. The conventional hand tool is strong but heavy so that when the conventional hand tool is used in water, such as maintenance for water pump, boats and valves under water, the conventional hand tool is difficult to keep in position. Usually, the user ties a rope to the hand tool to prevent lose it and this is inconvenient for the user who has to find the hand tool by pulling the rope.

Some manufacturers develop hand tools with hollow handle which includes a space defined therein and an opening is defined in an end of the handle. A nut is threadedly engaged with the opening so as to seal the space. By the space in the handle, the hand tool does not sink in water. However, there are gaps defined between the threads of the nut and the inner periphery of the opening so that water enters into the space, especially when the water pressure is significant. The conventional buoyant hand tool is not reliable.

The present invention intends to provide a buoyant hand tool that includes a space defined in the handle and the space is isolated and does not communicate with any opening so that the buoyant hand tool floats when working in water.

### SUMMARY OF THE INVENTION

The present invention relates to a buoyant hand tool which comprises a handle including a first part and a second part. At least one of the first part and the second part includes a first recess and a second recess which is not in communication with the first recess. The first and second parts are connected to each other by way of ultra sonic welding so that the first recess is formed to be a space in the handle and the second recess is in communication with outside of the handle. A function member is engaged with the second recess. The handle is buoyant in water.

The primary object of the present invention is to provide a buoyant hand tool wherein the space in the handle of the hand tool is isolation so that the buoyant hand tool is ensured to float in water.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the buoyant hand tool of the present invention;

FIG. 2 is a perspective view to show the buoyant hand tool of the present invention;

FIG. 3A is a cross sectional view, taken along line A-B in FIG. 2;

FIG. 3B is a cross sectional view, taken along line C-D in FIG. 2;

FIGS. 4-1 to 4-8 show different insertion of the function member of the buoyant hand tool of the present invention;

FIG. 5 is a perspective view to show a second embodiment of the buoyant hand tool of the present invention;

FIG. 6A is a cross sectional view, taken along line A-B in FIG. 5;

FIG. 6B is a cross sectional view, taken along line C-D in FIG. 5;

FIG. 7A is a perspective view to show a third embodiment of the buoyant hand tool of the present invention;

FIG. 7B is a cross sectional view to show the hand tool in FIG. 7A;

FIG. 8 is a partial cross sectional view of a fourth embodiment of the buoyant hand tool of the present invention;

FIG. 9 is a cross sectional view to show a fifth embodiment of the buoyant hand tool of the present invention;

FIG. 10A is a perspective view to show a sixth embodiment of the buoyant hand tool of the present invention;

FIG. 10B is a cross sectional view to show the buoyant hand tool in FIG. 10A, and

FIG. 11 shows that the buoyant hand tool of the present invention floats in water.

### DETAILED DESCRIPTION OF THE PREFERRED EMBODIMENT

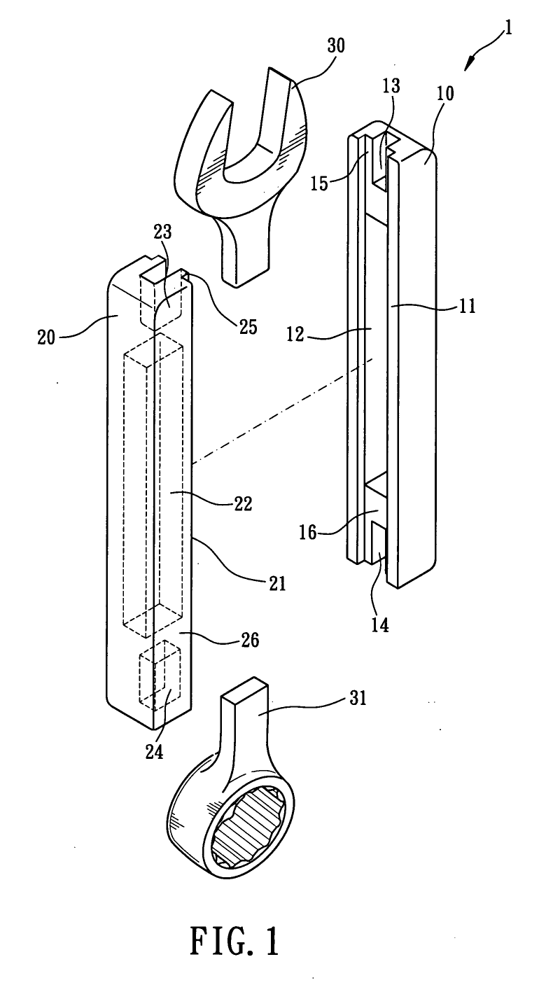

Referring to FIGS. 1, 2, 3A and 3B, the buoyant hand tool 1 of the present invention comprises a handle 40 composed of a first part 10 and a second part 20. A first recess 12/22 is defined in an inside of each of the first part 10 and the second part 20. Two second recesses 13, 14/23, 24 are respectively defined in two ends of each of the first and second parts 10, 20, the second recesses 13, 14/23. 24 are not in communication with the first recess 12/22. Two recessed areas 15, 16 are defined in the inside of the two ends of the first part 10 and two protrusions 25, 26 extend from the inside of the two ends of the second part. The protrusions 25, 26 are engaged with the recessed areas 15, 16 respectively. The first part 10 includes two first flanges 11 on two sides of the inside thereof and the second part 20 includes two second flanges 21 on two sides of the inside thereof. The first and second parts 10, 20 are connected to each other by way of ultra sonic welding so that the two first flanges 11 are connected to the second flanges 21, and the first recesses 12, 22 are formed to be a space 50 in the handle 40. The second recesses 13, 14/23, 24 are in communication with outside of the handle 40 so as to form two reception spaces in two ends of the handle 40.

Two function members 30, 31 are engaged with the two reception spaces formed by the second recesses 13, 14/23, 24. In this embodiment, the function member 30 is an open end and the function member 31 is a box end. The function member 30, 31 are made by metal material and a surface treatment is made to the function members 30, 31 to prevent from being rusted. The handle 40

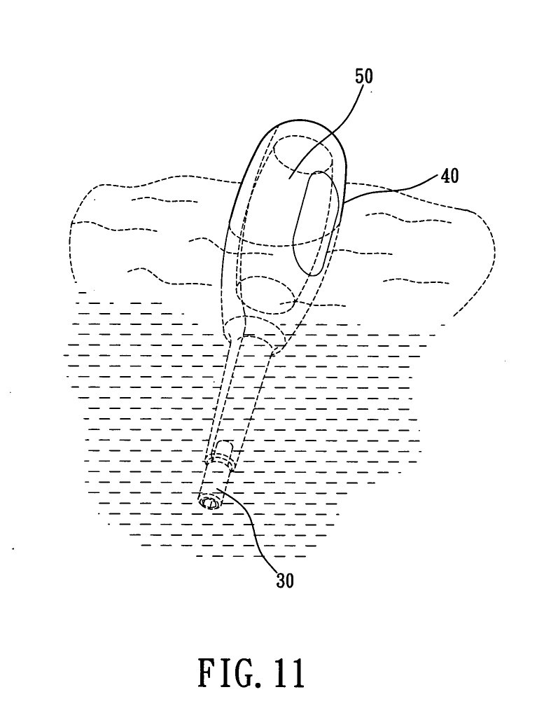

It is noted that the space 50 is isolated from the two reception spaces so that the air in the space 50 does not leakage and the space 50 in the handle 40 is filled with air so that the handle floats in water as shown in FIG. 11.

Each of the function members 30, 31 includes an insertion 32 which is securely inserted in the reception spaces. FIGS. 4-1 to 4-8 show different insertions of the function members 30, 31 of the buoyant hand tool of the present invention.

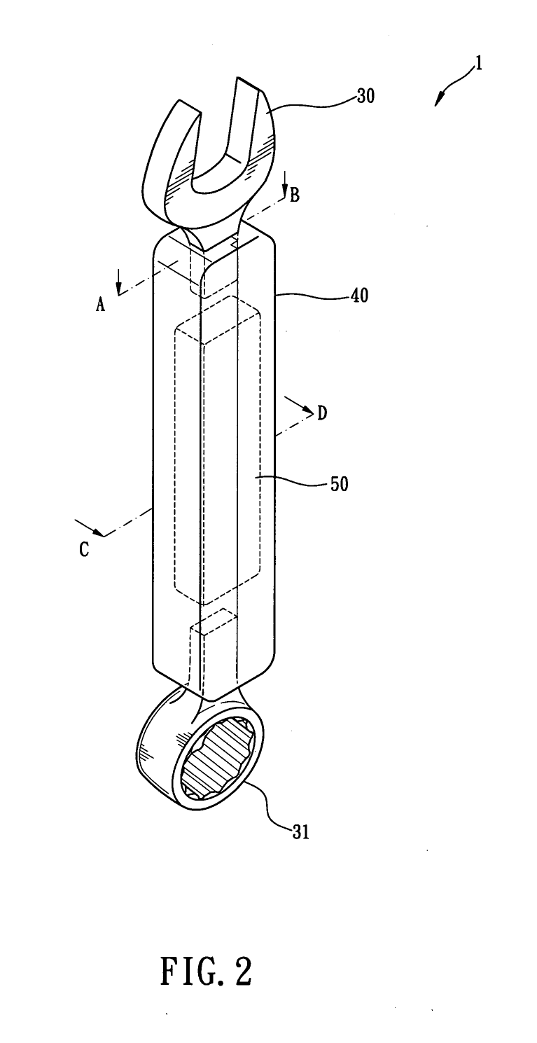

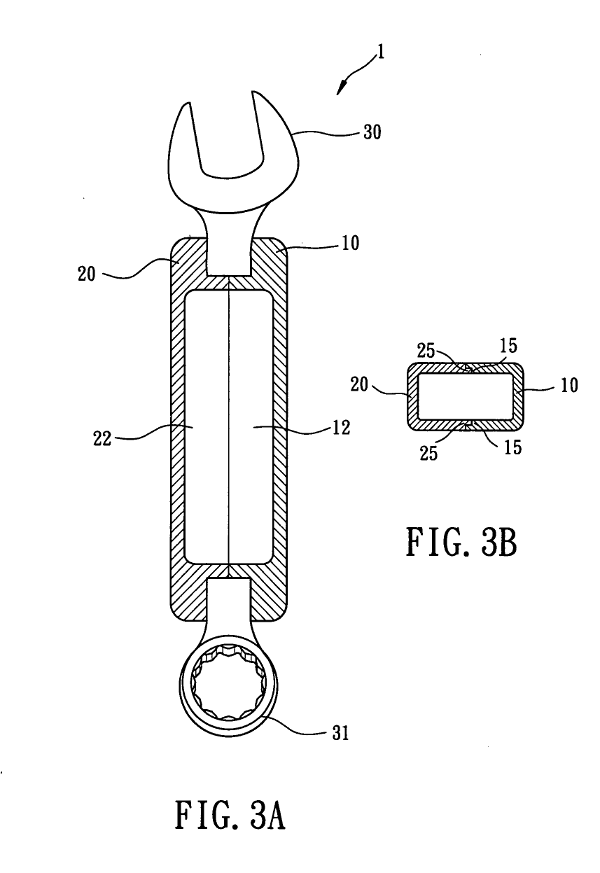

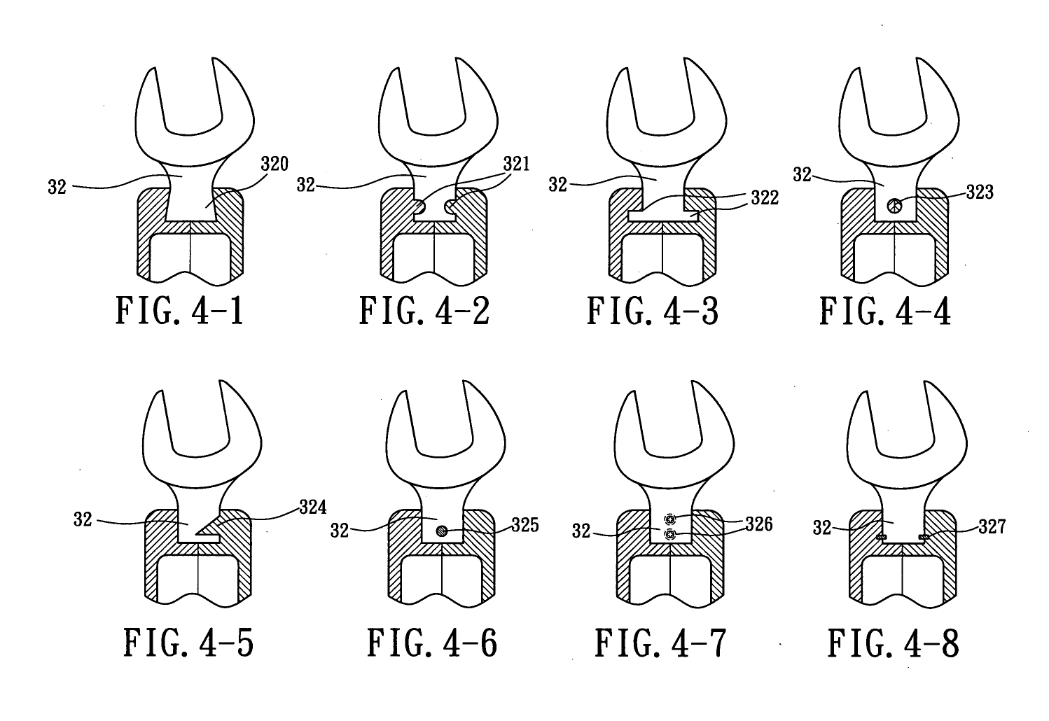

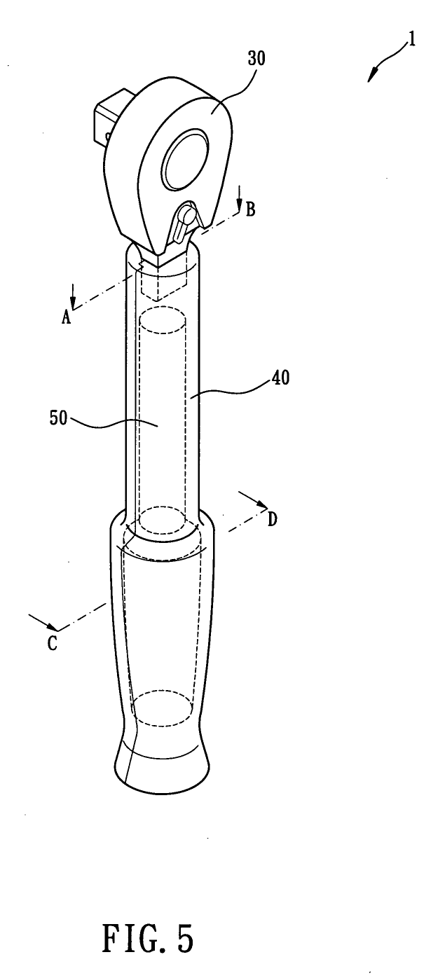

FIG. 4-1 shows that the insertion 32 includes a tapered end 320, FIG. 4-2 shows that the insertion 32 includes two notches 321 defined in two sides thereof, FIG. 4-3 shows that the insertion 32 includes two extensions 322 extending from two sides thereof, FIG. 4-4 shows that the insertion 32 includes a through hole 323 defined therethrough, FIG. 4-5 shows that the insertion 32 includes a triangular notch 324 defined in one of two sides thereof, FIG. 4-6 shows that the insertion 32 includes a rod 325 perpendicularly connected thereto, FIG. 4-7 shows that the insertion 32 is connected to the handle 40 by two bolts 326, and FIG. 4-8 shows that a C-clip 327 is mounted to the insertion 32 to position the insertion 32 in the reception space.

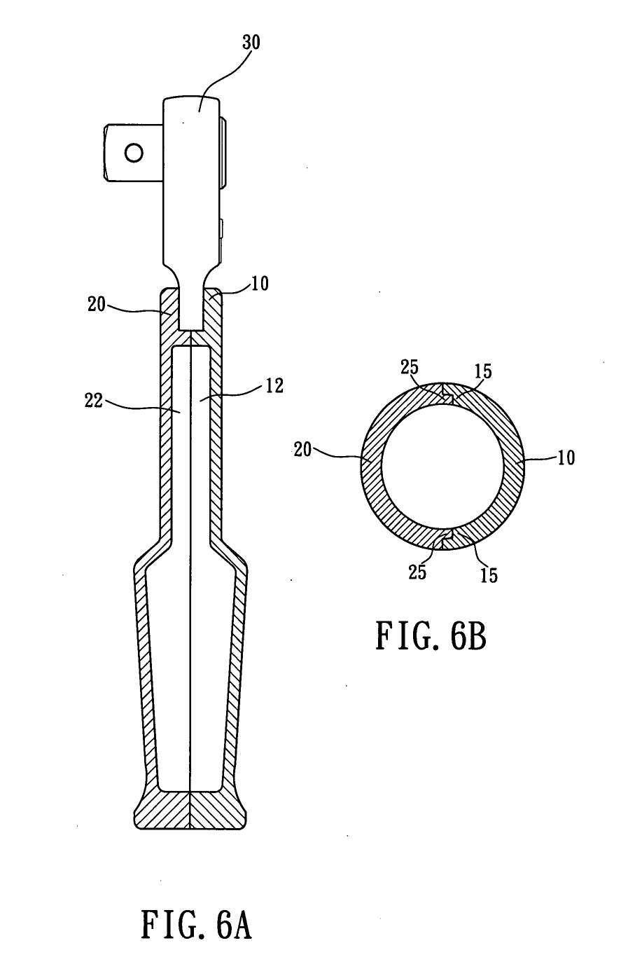

FIGS. 5, 6A and 6B show that the handle 40 has only one reception space and the function member 30 is engaged with the reception space. The function member 30 is a ratchet function member.

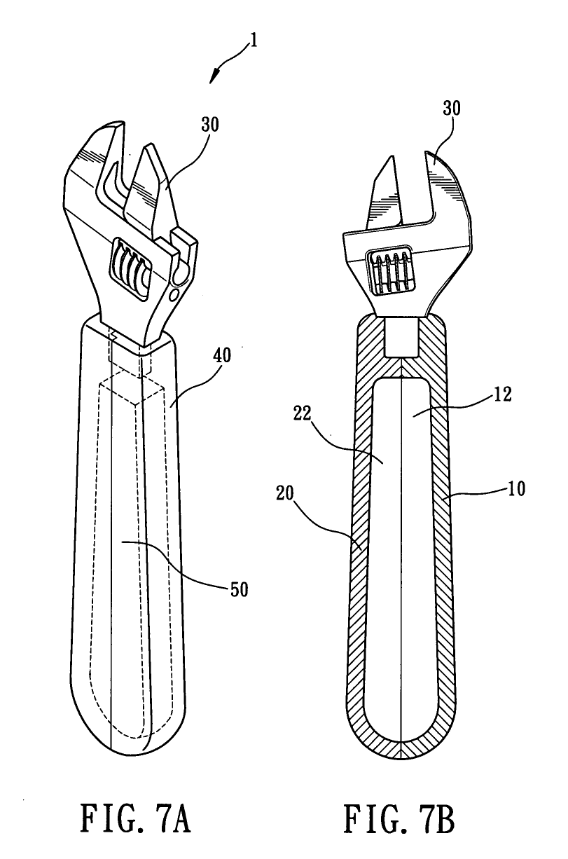

FIGS. 7A and 7B show that the handle 40 has only one reception space and the function member 30 is engaged with the reception space. The function member 30 is an adjustable wrench head.

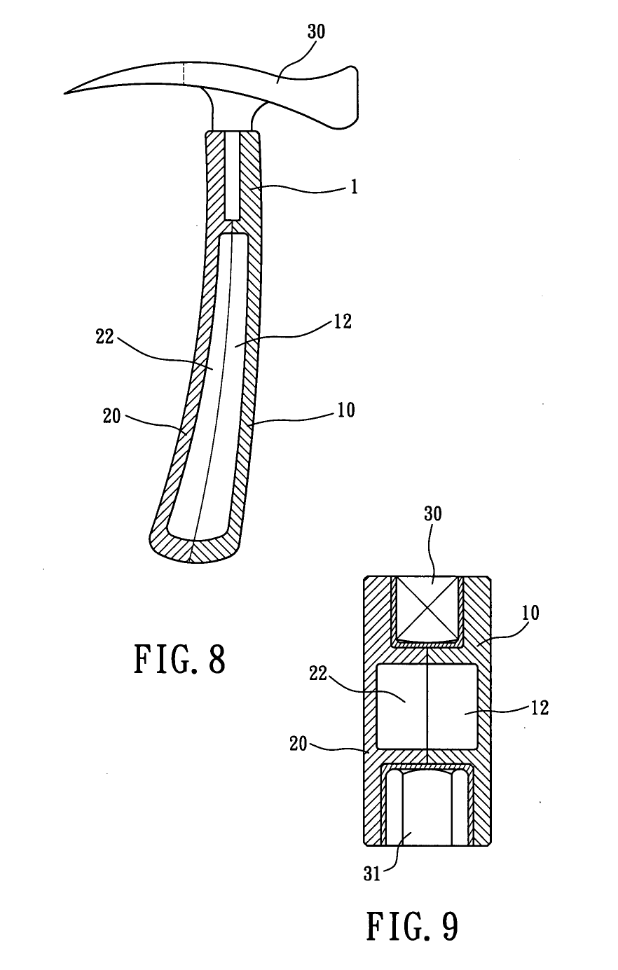

FIG. 8 shows that the handle has only one reception space and the function member 30 is engaged with the reception space. The function member 30 is a chisel head.

FIG. 9 shows that the handle has two reception spaces and each reception space is engaged with a polygonal member 30/31 which is used to mount on a nut or bolt head.

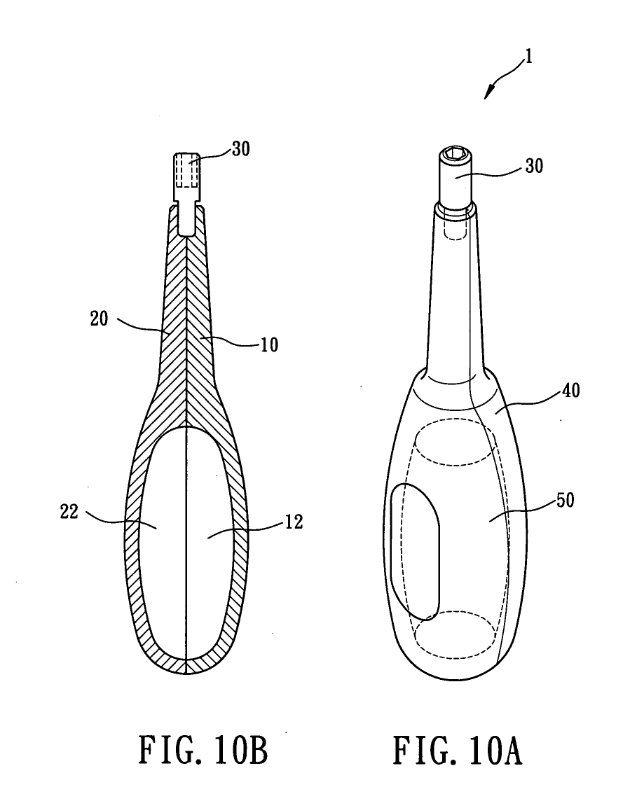

FIGS. 10A and 10B show that the handle 40 has only one reception space and the function member 30 is engaged with the reception space. The function member 30 is a bit adapter.

While we have shown and described the embodiment in accordance with the present invention, it should be clear to those skilled in the art that further embodiments may be made without departing from the scope of the present invention.

What is claimed is:

1. A buoyant hand tool comprising:
a handle composed of a first part and a second part, at least one of the first part and the second part including a first recess and a second recess which is not in communication with the first recess, the first and second parts being connected to each other by way of ultra sonic welding so that the first recess being formed to be a space in the handle, the second recess being in communication with outside of the handle, and
a function member engaged with the second recess.

2. The hand tool as claimed in claim 1, wherein a recessed area is defined in an inside of one of the first and second parts and a protrusion extends from an inside of the other one of the first and second parts, the protrusion is engaged with the recessed area.

3. The hand tool as claimed in claim 1, wherein the first part includes two first flanges on two sides of an inside thereof and the second part includes two second flanges on two sides of an inside thereof, the two first flanges are connected to the second flanges.

4. The hand tool as claimed in claim 1, wherein the handle includes two second recesses defined in two ends thereof.

5. The hand tool as claimed in claim 1, wherein the function member is made by metal material and a surface treatment is made to the function member to prevent from being rusted.

6. The hand tool as claimed in claim 1, wherein the function member includes an insertion which is inserted into the second recess, the insertion includes a tapered end.

7. The hand tool as claimed in claim 1, wherein the function member includes an insertion which is inserted into the second recess, the insertion includes two notches defined in two sides thereof.

8. The hand tool as claimed in claim 1, wherein the function member includes an insertion which is inserted into the second recess, the insertion includes two extensions extending from two sides thereof.

9. The hand tool as claimed in claim 1, wherein the function member includes an insertion which is inserted into the second recess, the insertion includes a through hole defined therethrough.

10. The hand tool as claimed in claim 1, wherein the function member includes an insertion which is inserted into the second recess, the insertion includes a triangular notch defined in one of two sides thereof.

11. The hand tool as claimed in claim 1, wherein the function member includes an insertion which is inserted into the second recess, the insertion includes a rod perpendicularly connected thereto.

12. The hand tool as claimed in claim 1, wherein the function member includes an insertion which is inserted into the second recess, the insertion is connected to the handle by two bolts.

13. The hand tool as claimed in claim 1, wherein the function member includes an insertion which is inserted into the second recess, a C-clip is mounted to the insertion.
